(19) United States
(12) Patent Application Publication
(10) Pub. No.: US 2023/0419356 A1
(43) Pub. Date: Dec. 28, 2023

(54) OPTIMIZED EXCHANGE RATES BASED ON USER PROFILES

(71) Applicant: Capital One Services, LLC, McLean, VA (US)

(72) Inventors: Michael MOSSOBA, Great Falls, VA (US); Myka COOPER, Woodbridge, VA (US); Trinity D. MOON, Bowie, MD (US)

(21) Appl. No.: 17/808,127

(22) Filed: Jun. 22, 2022

(51) Int. Cl. G06Q 30/02

(52) U.S. Cl. CPC G06Q 30/0228; G06Q 30/0209

(57) ABSTRACT

In some implementations, a device may obtain a first user profile associated with a first user that indicates: a first user gaming profile; a first use history, associated with program points, of the first user; and/or a first exchange history associated with the first user. The device may determine, using a machine learning model, a propensity score associated with the first user based on the first user profile that is based on a memory usage, associated with a gaming console, indicated by the first user gaming profile. The device may determine, based on the propensity score, a first exchange rate for converting the program points to the virtual points of the first game. The device may receive an indication of an exchange initiated by the first user. The device may communicate, with a device, to cause the one or more virtual points to be made available to a second account.

### BACKGROUND

A video game console (e.g., a gaming console) is an electronic device that outputs a video signal or image to display a video game that can be played by a user with a game controller. Video game consoles may include home consoles which may be placed in a permanent location connected to a television or other display device and controlled with a separate game controller. Video game consoles may also include handheld consoles that include a display unit and controller functions built into the unit such that the handheld console can be played anywhere. Hybrid consoles combine elements of both home and handheld consoles. Video game consoles are a specialized form of a computer devices for video game playing, designed with affordability and accessibility to the general public in mind, but that may be lacking in raw computing power and customizability.

A video game console may include, or may be associated with, a graphical user interface. A graphical user interface is a form of user interface that allows users to interact with electronic devices. A video game or an operating system executing on a video game console may provide a graphical user interface that presents gaming information and/or user profile information.

### SUMMARY

Some implementations described herein relate to a system for a user-specific exchange rate based on user profiles for converting program points to virtual points of a gaming platform. The system may include one or more memories and one or more processors coupled to the one or more memories. The one or more processors may be configured to obtain a first user profile associated with a first user, wherein the first user profile indicates at least one of: a first user gaming profile associated with the gaming platform; a first use history, associated with the program points, of the first user; or a first exchange history associated with the first user. The one or more processors may be configured to determine, using a machine learning model, a propensity score associated with the first user based on the first user profile, wherein the propensity score indicates a likelihood that the first user will convert the program points to virtual points of a first game, and wherein the propensity score is based on a memory usage, associated with the gaming platform or the first game, indicated by the first user gaming profile. The one or more processors may be configured to determine, based on the propensity score, a first exchange rate for converting the program points to the virtual points of the first game, wherein the program points are associated with a program associated with a first account of the first user, and wherein the first exchange rate is specific to the first user and the first game. The one or more processors may be configured to receive, via a user interface, an indication of an exchange initiated by the first user, wherein the exchange converts one or more of the program points to one or more virtual points of the first game according to the first exchange rate. The one or more processors may be configured to communicate, with a device, to cause the one or more virtual points to be made available to a second account that is associated with the first game.

Some implementations described herein relate to a method for determining an exchange rate for converting program points to digital assets of a gaming platform. The method may include obtaining, by a device, a first user profile associated with a first user. The method may include determining, by the device, a first exchange rate for converting the program points to digital assets of a first gaming application associated with the gaming platform, wherein the program points are associated with a program associated with a first account of the first user, wherein the first exchange rate is based on the first user profile, and wherein the first exchange rate is specific to the first user and the first gaming application. The method may include receiving, by the device and via a user interface associated with the first account, an indication of an exchange initiated by the first user, wherein the exchange converts one or more of the program points to one or more digital assets of the first gaming application according to the first exchange rate. The method may include communicating, by the device with a server device, to cause the one or more digital assets to be made available to a second account that is associated with the first gaming application.

Some implementations described herein relate to a non-transitory computer-readable medium that stores a set of instructions for a device. The set of instructions, when executed by one or more processors of the device, may cause the device to obtain a first user profile associated with a first user. The set of instructions, when executed by one or more processors of the device, may cause the device to determine a first exchange rate for converting program points to virtual points of a first game, wherein the program points are associated with a program associated with a first account of the first user, wherein the first exchange rate is based on the first user profile and one or more additional factors, and wherein the first exchange rate is specific to the first user and the first game. The set of instructions, when executed by one or more processors of the device, may cause the device to provide an indication of the first exchange rate for display via a user interface associated with the first account. The set of instructions, when executed by one or more processors of the device, may cause the device to receive, via the user interface, an indication of an exchange initiated by the first user, wherein the exchange converts one or more of the program points to one or more virtual points of the first game according to the first exchange rate. The set of instructions, when executed by one or more processors of the device, may cause the device to communicate, with another device, to cause the one or more virtual points to be made available to a second account, of the first user, that is associated with the first game.

### BRIEF DESCRIPTION OF THE DRAWINGS

FIGS. 1A-1C are diagrams of an example implementation relating to optimized exchange rates based on user profiles.

FIG. 2 is a diagram illustrating an example of training and using a machine learning model in connection with optimized exchange rates based on user profiles.

FIG. 3 is a diagram of an example environment in which systems and/or methods described herein may be implemented.

FIG. 4 is a diagram of example components of one or more devices of FIG. 3.

FIG. 5 is a flowchart of an example process relating to optimized exchange rates based on user profiles.

### DETAILED DESCRIPTION

The following detailed description of example implementations refers to the accompanying drawings. The same reference numbers in different drawings may identify the same or similar elements.

An account with an institution (e.g., a financial institution) may be associated with a program that provides points (e.g., referred to herein as “program points”) to a user (e.g., associated with the account) based on transactions or other actions performed by the user via the account. For example, the program may be a rewards program, an incentive program, a benefit program, a loyalty program, a cashback program, and/or a discount program, among other examples. For example, as used herein, “program points” may refer to rewards points, benefit points, loyalty points, cash-back points, and/or discount points, among other examples. For example, the account may be associated with a transaction card and the account may be credited with a certain number of program points based on a transaction amount of one or more transactions completed via the transaction card (e.g., the account may be credited with X program points for every Y U.S. Dollars in transactions completed via the transaction card).

In some cases, the user may be enabled to redeem program points for a benefit. For example, in some cases, program points may be redeemed for a cash value (e.g., a cashback reward). As another example, program points may be redeemed for points or credit associated with other entities (e.g., other than the institution), such as an airline (e.g., airline points), a restaurant (e.g., restaurant points), and/or a hotel (e.g., hotel points), among other examples. For example, the user may be enabled to transfer program points to the points associated with another entity (e.g., according to an exchange rate of program points to the points associated with the other entity). In such examples, the exchange rate may be based on a value of a real-world commodity. For example, a value of the program points may be based on a value of transactions completed via the account (e.g., which is based on a value of a real-world currency, such as the U.S. Dollar or the Euro) and a value of the points associated with the other entity may be based on a value of transactions that can be completed using the points (e.g., which is also based on the value of the real-world currency).

However, in some cases, program points may be transferred to virtual points that are associated with a virtual economy. A virtual economy may also be referred to as a synthetic economy. A virtual economy may be associated with an economy existing in a virtual world, such as in the context of an online game or a video game (e.g., “game,” “video game,” “gaming application,” and “online game” may be used interchangeably herein). The virtual points may be virtual currency in the context of the virtual world. Because the virtual economy may be synthetic (e.g., created for the purposes of a game), a value of a virtual point may not be based on, or tied to, a value of a real-world commodity or real-world currency.

As a result, determining an exchange rate for converting program points to virtual points may be difficult because the virtual points are not based on any real-world commodity and because virtual economies for different online games or video games may be different (e.g., a value of a first virtual point in a first video game may have a first value in a virtual economy of the first video game and a second virtual point in a second video game may have a second value in a virtual economy of the first video game). Additionally, different users may value virtual points differently. For example, a first user may associate a value (e.g., in terms of program points and/or real-world currency) with a first virtual point and a second user may associate a second value for the first virtual point. For example, the first user may own and/or frequently play a video game associated with the first virtual point, whereas the second user may not own or may not frequently play the video game. Therefore, the first value (e.g., associated with the first user) may be a higher value than the second value (e.g., associated with the second user). However, a system that determines the exchange rate for converting program points may be unable to determine an exchange rate that is appropriate (e.g., based on a value of a given virtual point associated with a given video game and/or virtual economy) because the system may not have access to information associated with the given video game and/or virtual economy. Additionally, the system may be unable to determine a personalized exchange rate for a given user and a given virtual point because the system does not have access to information associated with the given user that may indicate how the given user would value the given virtual point (e.g., because such information is based on the user's interactions within a virtual economy and/or a video game that is not associated with the institution and/or real-world interactions).

Therefore, a universal exchange rate (e.g., that is the same for all users) may be used to convert program points to a given virtual point, where the universal exchange rate is inaccurate (e.g., because the universal exchange rate is determined without information associated with the virtual economy associated with the given virtual point) and/or inefficient (e.g., because the universal exchange rate is determined without information associated with how a given user values the given virtual point). As a result, computing resources (e.g., processing resources and/or memory resources) may be consumed by the system attempting to determine an accurate and/or efficient exchange rate for the given virtual point. For example, the system may be required to perform several iterations of determining an exchange rate, deploying the exchange rate to be used by users, receiving feedback associated with redemptions and/or conversions performed by users based on the exchange rate, and adjusting the exchange rate based on the feedback, until an accurate and/or efficient exchange rate is determined by the system, thereby consuming significant computing resources.

Some implementations and techniques described herein enable optimized exchange rates (e.g., for converting program points to a given virtual point) based on user profiles. For example, a point conversion device may obtain a user profile associated with a user. The user profile may indicate a user gaming profile associated with a gaming platform. As used herein, “gaming platform” may refer to a platform associated with a video game system, a gaming console, and/or an online game. For example, the point conversion device may receive the user gaming profile from a gaming console. In some implementations, the user gaming profile may indicate one or more categories of games associated with the user (e.g., based on video games installed on, or saved in a memory of, the gaming console), a gaming experience level associated with the first user (e.g., based on user interactions performed via the gaming console that are stored in a memory of the gaming console), and/or an indication of an amount of time that the first user has been active on a given gaming platform and/or a given game (e.g., based on how much memory has been allocated to the given gaming platform and/or the given game by the gaming console), among other examples. In other words, the user gaming profile may indicate memory usage information associated with the gaming console that indicates information related to a gaming platform usage and/or a video game usage by the user associated with the user gaming profile.

The point conversion device may determine, using a machine learning model, a propensity score associated with the user based on the first user profile. The propensity score may indicate a likelihood that the user will convert program points to virtual points of a given game. The propensity score may be based on the user gaming profile and/or other information, such as an exchange history associated with the user (e.g., a transaction history), a release date of the game, a release date of a feature or content associated with the game, an acquisition date of the first game by the user, and/or an acceptance rate of exchanges according to other exchange rates associated with the game and associated with other users, among other examples. In some implementations, the propensity score may be based on a memory usage, associated with the gaming platform or the first game, indicated by the user gaming profile (e.g., the gaming console may track a memory usage associated with the game and may indicate the memory usage to the point conversion device via the user gaming profile). The point conversion device may determine, based on the propensity score, an optimized exchange rate for converting the program points to the virtual points of the game. The optimized exchange rate may be specific to the user and the game. In some implementations, the optimized exchange rate may be optimized for the user to incentivize the user to exchange the program points for the virtual points based on the propensity score. In other words, the point conversion device may use a machine learning system that applies a rigorous and automated process to determine a propensity score for a given user and a given game (e.g., a given video game). The point conversion device may determine an optimized exchange rate, for the user and based on the propensity score, for converting program points to virtual points associated with the given game. As a result, the point conversion device may be enabled to determine the optimized exchange rate quickly and accurately. This may conserve computing resources that would have otherwise been used by the point conversion device to perform one or more iterations of determining an exchange rate, deploying the exchange rate to be used by users, receiving feedback associated with redemptions and/or conversions performed by users based on the exchange rate, and adjusting the exchange rate based on the feedback, until the optimized exchange rate is determined.

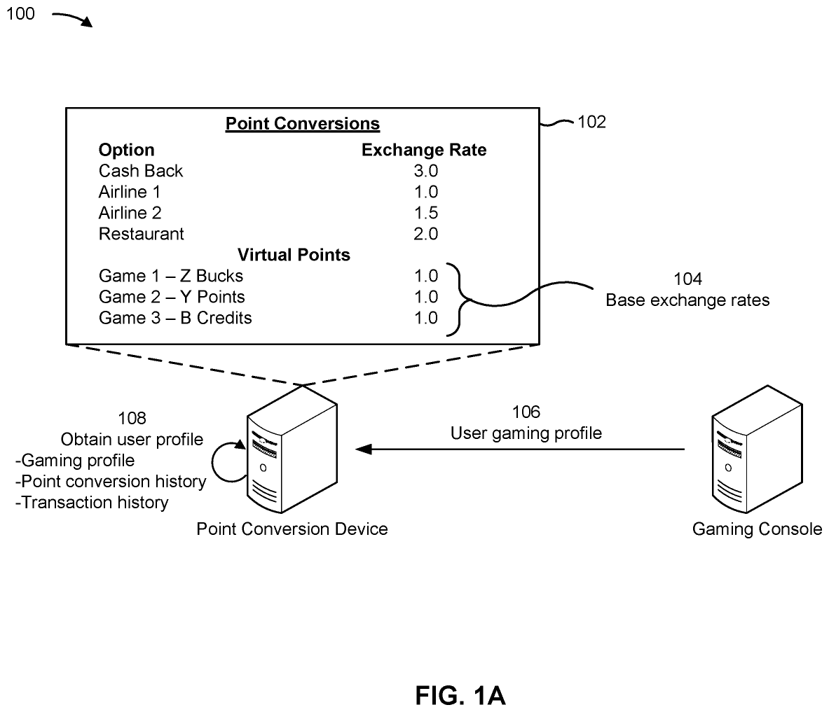

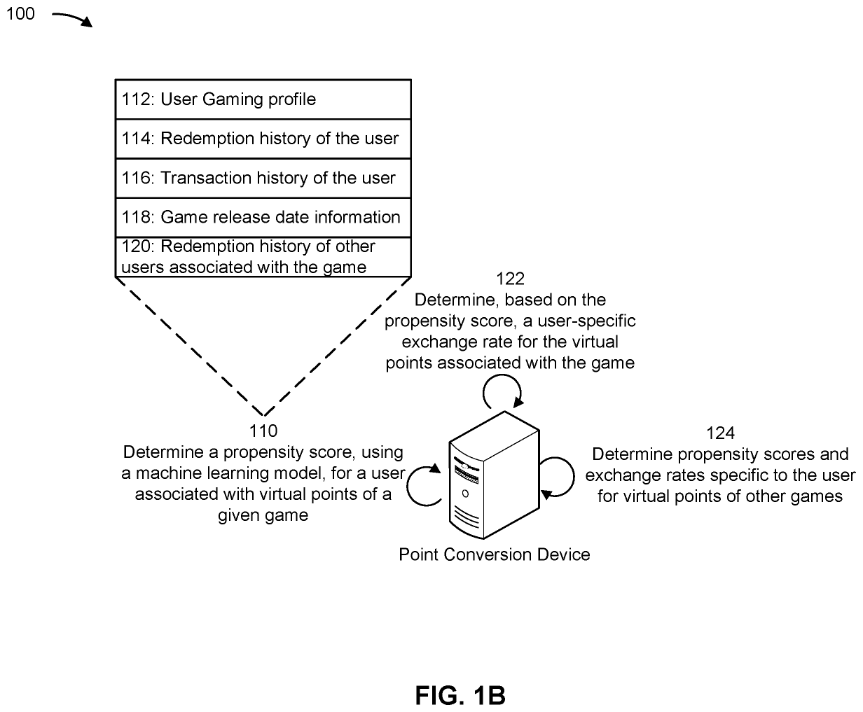

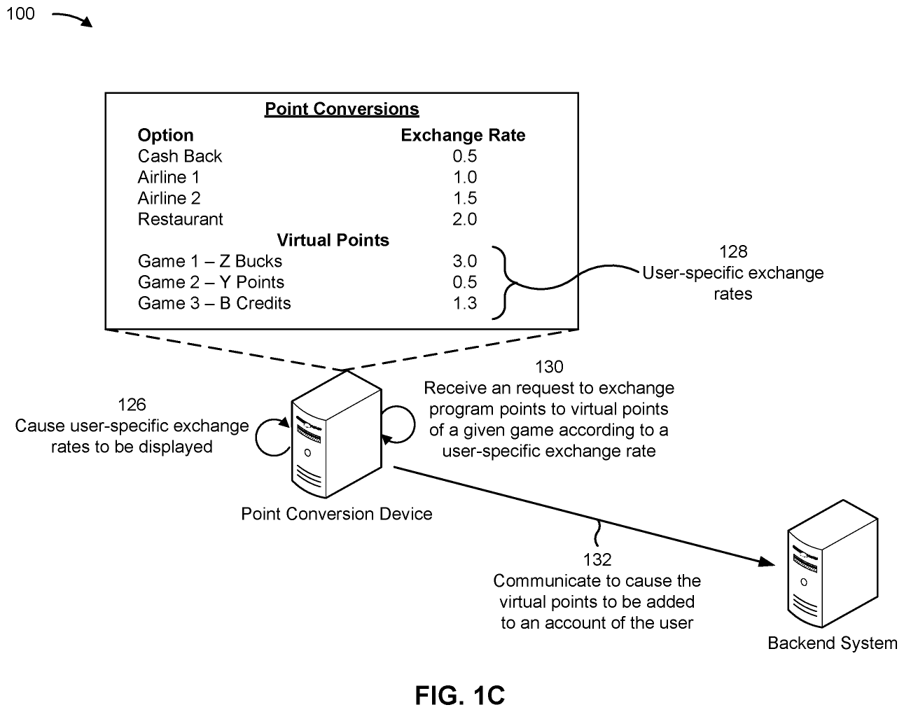

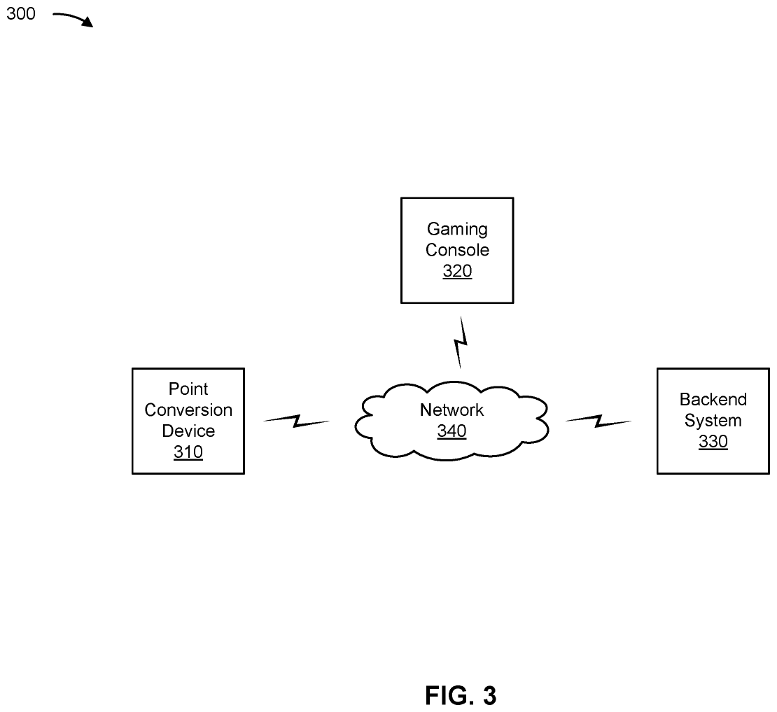

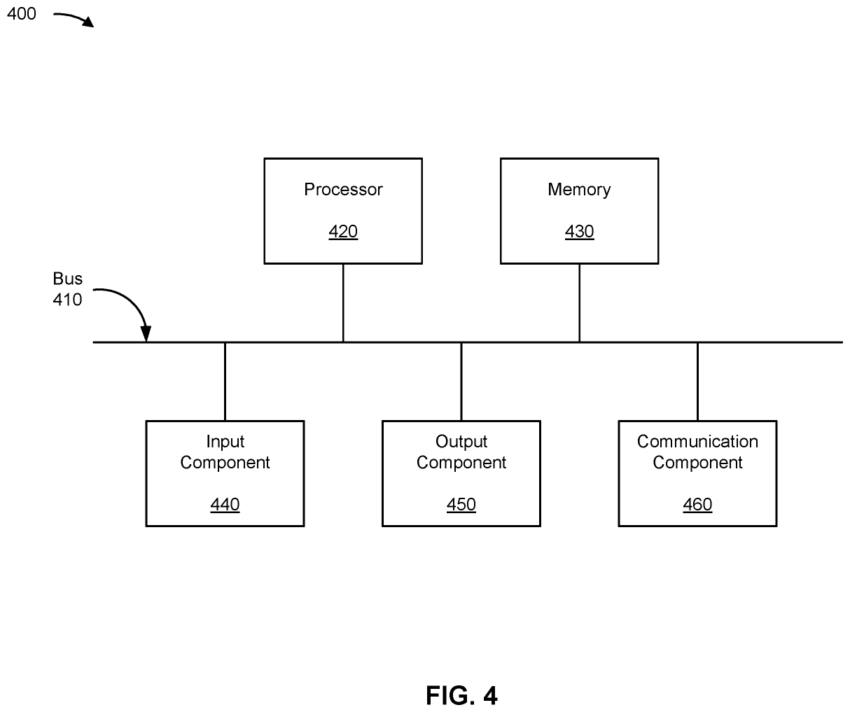

FIGS. 1A-1C are diagrams of an example 100 associated with optimized exchange rates based on user profiles. The optimized exchange rate may be for converting program points to a given virtual point. As shown in FIGS. 1A-1C, example 100 includes a point conversion device, a gaming console, and a backend system. These devices are described in more detail in connection with FIGS. 3 and 4.

The point conversion device may be associated with an institution. The institution may provide and/or manage accounts (e.g., transaction accounts, credit accounts, and/or debit accounts). The institution may provide a program that provides points (e.g., referred to herein as “program points”) to a user (e.g., associated with the account) based on transactions or other actions performed by the user via the account, as described in more detail above. For example, program points may be earned via one or more transactions with one or more entities via the account associated with the user (e.g., via a transaction card associated with the account).

As shown in FIG. 1A, the point conversion device may determine various exchange rates for converting program points to other points and/or benefits. For example, as shown by reference number 102, the point conversion device may determine exchange rates for converting program points to benefits or points that are associated with a real-world commodity or currency. The exchange rates described herein may be described as converting from program points to other points (e.g., an exchange rate of 2.0 may indicate that 2 program points can be converted or redeemed for 1 point, and an exchange rate of 0.5 may indicate that 1 program point can be converted or redeemed for 2 points). For example, as shown in FIG. 1A, the point conversion device may determine an exchange rate of 3.0 for a cash back option associated with a real-world currency, such as the U.S. Dollar or the Euro (e.g., indicating that 3 program points can be redeemed for, or converted to, 1 U.S. Dollar, 1 Euro, or 1 unit of another real-world currency). As another example, the point conversion device may determine an exchange rate of 1.0 for converting program points to points associated with a first airline (“Airline 1”) (e.g., indicating that 1 program point can be redeemed for, or converted to, 1 point associated with the first airline). As another example, the point conversion device may determine an exchange rate of 1.5 for converting program points to points associated with a second airline (“Airline 2”) (e.g., indicating that 3 program points can be redeemed for, or converted to, 2 points associated with the second airline). As another example, the point conversion device may determine an exchange rate of 2.0 for converting program points to points associated with a restaurant (e.g., indicating that 2 program points can be redeemed for, or converted to, 1 point associated with the restaurant).

The cash back option, if selected by the user, may cause a credit to be applied to the account associated with the user in the amount of the currency redeemed by the user (e.g., based on the exchange rate and the quantity of program points redeemed or converted by the user). The points associated with other entities may cause the redeemed or converted points to be made available to a second account associated with the user. For example, if the user selects to redeem program points for the points associated with the first airline, then the point conversion device may cause a quantity of the points associated with the first airline to be made available in an account associated with the first airline (e.g., an account indicated by the user when redeeming or converting the program points), where the quantity of the points made available is based on the exchange rate (e.g., 1.0) and a quantity of program points redeemed or converted as indicated by the user.

As shown in FIG. 1A, the point conversion device may cause a set of exchange rates associated with the program points to be presented for display (e.g., via a user interface). For example, the user may sign in, or log in, to a user interface associated with the account. The user may navigate to a page of the user interface that is associated with the program points. The point conversion device may cause the set of exchange rates associated with the program points to be presented for display via the page.

As shown in FIG. 1A, the set of exchange rates may include one or more exchange rates for converting program points to various virtual points. As described in more detail above, virtual points may be associated with a virtual economy and/or a video game or application. For example, a virtual point, associated with a given video game, may be used to acquire in-game digital assets associated with the given video game. In some implementations, a value of the virtual points may not be based on, or tied to, a value of a real-world commodity or real-world currency.

As shown by reference number 104, the point conversion device may determine one or more base exchange rates for various virtual points. A base exchange rate may be an initial exchange rate determined by the point conversion device (e.g., without additional information and/or personalization to a given user). For example, a base exchange rate may be an exchange rate for converting program points to virtual points that is determined, by the point conversion device, prior to the point conversion device receiving information associated with the user and/or a video game or application associated with the virtual points. In some implementations, a base exchange rate may be an exchange rate for converting program points to virtual points that is determined, by the point conversion device, using information associated with the video game or application associated with the virtual points, but not using information associated with the user (e.g., not using information indicated by a user profile, as described in more detail elsewhere herein). Additionally, or alternatively, the base exchange rates may be based on a historical acceptance rate or a use rate (e.g., a rate at which users are converting program points to virtual points) associated with other users. For example, as shown in FIG. 1A, the point conversion device may determine a first base exchange rate (e.g., 1.0) for a first virtual point (e.g., “Z Bucks”) associated with a first game (e.g., “Game 1”), a second base exchange rate (e.g., 1.0) for a second virtual point (e.g., “Y Points”) associated with a second game (e.g., “Game 2”), a third base exchange rate (e.g., 1.0) for a third virtual point (e.g., “B credits”) associated with a third game (e.g., “Game 3”), and so on. In some implementations, the base exchange rates may be the same for all virtual points (e.g., as shown in FIG. 1A). In some other implementations, a first base exchange rate associated with a first virtual point and a first game may be different than a second base exchange rate associated with a second virtual point and a second game.

The base exchange rates may be used to enable a user to convert program points to virtual points in scenarios where the point conversion device has not received a user profile, and/or has not received permission to access the user profile (e.g., from the user), among other examples. Additionally, the base exchange rates may be used as a starting point, or a reference point, for determining an optimized exchange rate for the user (e.g., the point conversion device may determine whether, and by how much, the base exchange rate should be modified based on information indicated by the user profile). Additionally, or alternatively, the base exchange rates may be used by the point conversion device to receive feedback associated with an acceptance rate or a use rate (e.g., a rate at which users are converting program points to virtual points according to a base exchange rate) associated with the base exchange rate. The feedback may enable the point conversion device to improve a determination of an optimized exchange rate for the user.

In some implementations, the user may provide permission, to the point conversion device, to access a user gaming profile associated with the user. For example, the user may provide, to the point conversion device, account information associated with an account of the user with a platform (e.g., a gaming platform) associated with the gaming console. The point conversion device may communicate with the gaming console (or a server device associated with the gaming console) to authenticate the user based on the account information. If the user is authenticated, then the point conversion device may communicate with the gaming console and/or the server device to obtain the user gaming profile.

For example, as shown by reference number 106, the gaming console (or a server device associated with the gaming console) may transmit, and the point conversion device may receive, an indication of the user gaming profile associated with the user. The user gaming profile may indicate a typical pattern of use of the gaming console by the user, a gaming behavioral pattern associated with the user, a gaming experience level associated with the user, and/or video games or applications typically played by the user via the gaming console, among other examples. The user gaming profile may be based on interactions associated with the user and the gaming console. For example, the user gaming profile may indicate a typical behavior associated with the user and the gaming console. In some implementations, the gaming console may receive permission from the user to track, maintain, and/or transmit the user gaming profile. For example, the gaming console may receive permission from the user to provide the user gaming profile as part of the application information to facilitate fraud detections associated with the application.

In some implementations, the user gaming profile may be based on a memory usage of the gaming console. For example, the gaming console may track how much memory is used for, or allocated for, certain video games or applications executing on the gaming console. The gaming console may use the memory usage of the gaming console to determine information for the user gaming profile, as described below. For example, the memory usage may indicate games or applications typically played by the user, and/or may indicate how often or frequently the user plays a given game or application, among other examples. The gaming console may track the memory usage associated with the user over time to obtain the user gaming profile.

Additionally, or alternatively, the gaming console may track interactions performed by the user, in connection with the gaming console, over time to obtain the user gaming profile. For example, the gaming console may track and/or obtain interactions associated with the user and various video games or applications executing on the gaming console. In some implementations, the user gaming profile may indicate one or more games or applications associated with the user. For example, the user gaming profile may indicate one or more games (e.g., video games) or applications that are owned by the user, that have been executed on the gaming console previously, and/or that are stored by the gaming console.

In some implementations, the user gaming profile may indicate a gaming behavioral pattern associated with the user. The gaming behavioral pattern may indicate a type or category of games typically played by the user (e.g., sports games, first-person shooter games, role playing games, action games, simulation games, and/or other types of games). Additionally, or alternatively, the gaming behavioral pattern may indicate temporal patterns associated with a use of the gaming console by the user. For example, the gaming behavioral pattern may indicate how often the user typically uses the gaming console, a time of day that the user typically uses the gaming console, and/or an amount of time that the user typically uses the gaming console (e.g., in a given sitting), among other examples. In some implementations, the gaming behavioral pattern may indicate a pattern of games typically played by the user (e.g., in an ordered pattern or sequential pattern). In some implementations, the gaming behavioral pattern may indicate which games the user typically plays more often (e.g., as compared to other games owned or played by the user). For example, the gaming behavioral pattern may indicate that the user plays game one 60% of the time that the user is interacting with the gaming console, game two 20% of the time that the user is interacting with the gaming console, game three 5% of the time that the user is interacting with the gaming console, and so on. The gaming behavioral pattern may be based on a memory usage, tracked by the gaming console, associated with various video games or applications.

In some implementations, the user gaming profile may indicate a gaming experience level associated with the user. The gaming experience level may indicate a skill level associated with the user. For example, the gaming console may track an amount of time that the user has played one or more games (e.g., if the user has spent more time playing a particular game, then the gaming console may determine that the user is more experienced in that particular game), a speed or frequency of inputs for a certain game (e.g., if the user inputs or triggers inputs to the video game faster for certain types of games, such as first-person shooter games, the speed or frequency of the inputs may indicate that the user is more skilled or more experienced for the type of games), scores achieved by the user when playing one or more games, and/or a ranking associated with the user for one or more games (e.g., obtained via one or more platforms associated with the one or more games), among other examples. The gaming experience level may indicate a behavior of the user when the user is interacting with or playing one or more games, a particular game, and/or a type or category of games, among other examples. The gaming experience level may indicate a likelihood that the user is to redeem program points for virtual points (e.g., a more experienced user may be more likely to redeem program points for virtual points than a less experienced user because the more experienced user is more likely to play the video games and/or use the virtual points).

As shown by reference number 108, the point conversion device may obtain the user profile associated with the user. The user profile may include the user gaming profile (e.g., associated with the gaming console and/or a gaming platform associated with the gaming console). Additionally, or alternatively, the user profile may include a point conversion history (e.g., a use history, associated with the program points, of the first user). The point conversion history may indicate a program point redemption history associated with the user. For example, the point conversion history may indicate whether the user typically redeems or converts program points or whether the user typically does not redeem program points (e.g., and builds up a higher balance of program points before redeeming or converting the program points). The point conversion history may indicate a likelihood that the user is to redeem or convert program points for virtual points. Additionally, or alternatively, the user profile may include a transaction history associated with the user (e.g., an exchange history associated with the user). “Transaction” may be used interchangeably with exchange, purchase, and/or sale, among other examples, herein. The transaction history may indicate information associated with historical transactions associated with the user and/or the account. For example, the transaction history may indicate whether the user shops at entities that sell video games (e.g., thereby increasing a likelihood that the user would redeem program points for virtual points because the likelihood that the user owns and/or plays video games is higher).

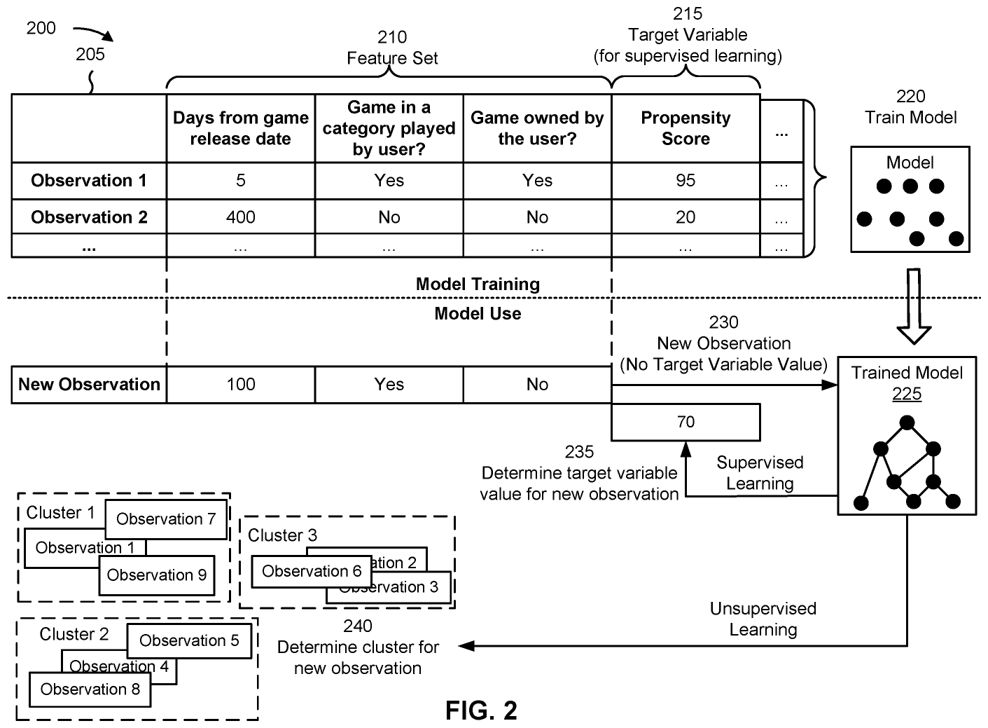

As shown in FIG. 1B, and by reference number 110, the point conversion device may determine a propensity score associated with the user and a given game (e.g., a given video game and/or application). The propensity score may indicate a likelihood that the first user will convert the program points to virtual points of the given game. For example, the propensity score may indicate a likelihood that the user would use the virtual points of the given game. In some implementations, the point conversion device may determine the propensity score using a machine learning model. For example, the point conversion device may input information that is based on the user profile and/or one or more additional factors into the machine learning model, and the machine learning model may output the propensity score. For example, parameters indicated by the first user profile and the one or more additional factors may be provided as inputs to the machine learning model. In some implementations, a feedback loop may be used to train and/or update the machine learning model. Training and using the machine learning model to determine the propensity score and the optimized exchange rate for a given user and video game is depicted and described in more detail in connection with FIG. 2.

Reference numbers 112-120 depict examples of information that can be used to determine the propensity score. For example, the information depicted by reference numbers 112-120 depicts examples of information that may be input to the machine learning model. The propensity score may be based on behavioral data associated with the user and/or associated with other users. The behavioral data may be based on the examples of information described above in connection with reference number 112-120.

For example, as shown by reference number 112, the propensity score may be based on the user gaming profile associated with the user. For example, the propensity score may be based on a memory usage, associated with the gaming platform, the gaming console, and/or the game, indicated by the user gaming profile. The user gaming profile may indicate a likelihood that the user will play the game. For example, the user gaming profile may indicate whether the game (e.g., that is associated with the virtual points and the exchange rate) is associated with a category that is included in one or more categories of games associated with the user (e.g., as indicated by the user gaming profile). For example, the one or more categories of games associated with the user may be categories of games that are typically played by the user. If the category of the game is included in the one or more categories of games, then the propensity score may indicate a higher likelihood that the user will convert the program points to virtual points of the game. If the category of the game is not included in the one or more categories of games, then the propensity score may indicate a lower likelihood that the user will convert the program points to virtual points of the given game. As another example, if the user gaming profile (e.g., if memory usage information of the gaming console) indicates that the game is owned and/or played by the user, then the propensity score may indicate a higher likelihood that the user will convert the program points to virtual points of the game. If the user gaming profile (e.g., if memory usage information of the gaming console) indicates that the game is frequently played by the user (e.g., based on an amount of time that the user has played the game via the gaming console), then the propensity score may indicate a higher likelihood that the user will convert the program points to virtual points of the game. As another example, if the user gaming profile (e.g., if memory usage information of the gaming console) indicates that the game is infrequently played by the user (e.g., if the amount of time that the user has played the game via the gaming console is below a threshold or if the user has not played the game in a threshold amount of time), then the propensity score may indicate a lower likelihood that the user will convert the program points to virtual points of the game.

As another example, if the gaming experience level associated with the user indicates that the user is experienced, then the propensity score may indicate a higher likelihood that the user will convert the program points to virtual points of the game (e.g., because the user is more likely to play the game if the user is experienced and/or plays video games often). In some implementations, the user gaming profile may indicate an amount of time that the first user has been active on a gaming platform and/or the game (e.g., based on memory usage and/or power status tracking of the gaming console). If the user gaming profile indicates that the amount of time that the first user has been active on the gaming platform and/or the game is high (e.g., satisfies a threshold), then the propensity score may indicate a higher likelihood that the user will convert the program points to virtual points of the game. If the user gaming profile indicates that the amount of time that the first user has been active on the gaming platform and/or the game is low (e.g., does not satisfy the threshold), then the propensity score may indicate a lower likelihood that the user will convert the program points to virtual points of the game.

In some implementations, as shown by reference number 114, the propensity score may be based on a redemption history of the user (e.g., of program points). The redemption history may be indicated by the user profile associated with the user. The redemption history may also be referred to as a use history herein. For example, the redemption history may indicate a quantity of instances in which the user redeemed program points, a quantity of instances in which the user redeemed program points for virtual points (e.g., of the game or other games), a periodicity or a frequency in which the user redeems program points, and/or a typical or average program point balance of the account when the user initiates a redemption of program points, among other examples. For example, the redemption history may indicate a likelihood that the user will redeem program points. For example, if the user often redeems program points or redeems program points when a program point balance of the account is low, then the propensity score may indicate a higher likelihood that the user will convert the program points to virtual points of the game (e.g., because the user is more likely to redeem program points in general). However, if the user does not often redeem program points or redeems program points only when a program point balance of the account is high, then the propensity score may indicate a lower likelihood that the user will convert the program points to virtual points of the game (e.g., because the user is less likely to redeem program points in general).

In some implementations, as shown by reference number 116, the propensity score may be based on a transaction history of the user. The transaction history may be indicated by the user profile associated with the user. The transaction history may also be referred to as an exchange history herein. The transaction history may be associated with the account of the user. The transaction history may indicate a likelihood that the first user has purchased the game. For example, the transaction history may indicate information associated with transactions completed via a transaction card associated with the account. In some implementations, the transaction history may indicate whether the user has purchased goods or services associated with the game or the gaming console. For example, the transaction history may indicate that the user has purchased the game and/or has purchased content or other goods associated with the game (e.g., thereby resulting in a propensity score that indicates a higher likelihood that the user will convert the program points to virtual points of the game).

The transaction history may indicate one or more entities associated with transactions completed via the account (e.g., one or more entities that are associated with a threshold quantity of transactions, thereby indicating that the user typically or frequency shops at the one or more entities). For example, if the one or more entities are associated with providing or selling goods or services associated with video games, then the propensity score may indicate a higher likelihood that the user will convert the program points to virtual points of the game (e.g., because the user is more likely to shop at an entity that sells goods or services associated with video games). As another example, the transaction history may indicate a category or type of entity associated with the account and/or the user. In some implementations, the propensity score may be based on the category or type of entity. For example, a user may be more likely to play a certain game if the user shops or transacts with a given category or type of entity (e.g., a user that shops at a sporting goods store may be more likely to play a sports video game).

In some implementations, as shown by reference number 118, the propensity score may be based on game release date information associated with the game. The game release date information may indicate a first release date of the game (e.g., a date on which the game was made publicly available, or offered for sale, for the first time). For example, if the first release date is close (e.g., within a threshold quantity of days) to a current date, then the propensity score may indicate a higher likelihood that the user will convert the program points to virtual points of the game (e.g., because the user is more likely to play the game or use the virtual points closer to the first release date of the game). If the first release date is further from (e.g., not within a threshold quantity of days of) a current date, then the propensity score may indicate a lower likelihood that the user will convert the program points to virtual points of the game (e.g., because the user is less likely to play the game or use the virtual points if the game has been released and available for a longer period of time). In other words, a user may be less likely to play an older game and may be more likely to play a newer game. As a result, the propensity score may be based on the first release date of the game and a current date.

The game release date information may indicate a second release date of a feature or content associated with the game. For example, content or features, such as a new map, new playable characters, new digital assets, and/or other content, may be made available in the game (e.g., after the first release date). If the second release date is close (e.g., within a threshold quantity of days) to a current date, then the propensity score may indicate a higher likelihood that the user will convert the program points to virtual points of the game (e.g., because the user is more likely to play the game or use the virtual points closer to a date at which new content or features are made available in the game). In some implementations, the game release date information may indicate an acquisition date of the game by the user (e.g., a date on which the user purchased or acquired the game). If the acquisition date is close (e.g., within a threshold quantity of days) to a current date, then the propensity score may indicate a higher likelihood that the user will convert the program points to virtual points of the game (e.g., because the user is more likely to play the game or use the virtual points closer to a date at which the user purchased or acquired the game). If the acquisition date is further from (e.g., not within a threshold quantity of days of) a current date, then the propensity score may indicate a lower likelihood that the user will convert the program points to virtual points of the game (e.g., because the user is less likely to play the game or use the virtual points if the game has been owned by the user for a long period of time).

In some implementations, as shown by reference number 120, the propensity score may be based on a redemption history of other users associated with the game. For example, the propensity score may be based on an acceptance rate of exchanges according to other exchange rates associated with the game and associated with other users. For example, the point conversion device may determine a rate at which other users are redeeming program points for the virtual points associated with the game (e.g., according to a base exchange rate for the game and/or personalized exchange rates associated with the other users). For example, the rate at which other users are redeeming program points for the virtual points associated with the game may indicate a popularity of the game and/or the virtual points with the general public. Therefore, if the rate at which other users are redeeming program points for the virtual points associated with the game is high, then the propensity score may indicate a higher likelihood that the user will convert the program points to virtual points of the game. If the rate at which other users are redeeming program points for the virtual points associated with the game is low, then the propensity score may indicate a lower likelihood that the user will convert the program points to virtual points of the game.

As shown by reference number 122, the point conversion device may determine, based on the propensity score, a user-specific exchange rate for the virtual points associated with the game. The user-specific exchange rate may be specific to the user and the game. The point conversion device may determine the user-specific exchange rate based on the propensity score (e.g., that is determined using the machine learning model). In some implementations, the user-specific exchange rate may be an optimized exchange rate. For example, the user-specific exchange rate may be optimized to conserve the program points and cause the user to accept an offer to convert the program points to the virtual points (e.g., to one or more digital assets associated with the game). For example, the optimized exchange rate may be a highest exchange rate for the user that is likely to incentivize the user to exchange the program points for the virtual points based on the propensity score. The optimized exchange rate may be the highest exchange rate such that the institution does not allow for more program points to be redeemed than are necessary to incentivize the user to exchange the program points for the virtual points (e.g., the optimized exchange rate may place a highest value on the program points relative to the virtual points that is still likely to incentivize the user to exchange the program points for the virtual points).

In some implementations, the point conversion device may determine the user-specific exchange rate based on information associated with a virtual economy of the game. For example, different games may value virtual points differently based on the virtual economies of the game (e.g., 10 virtual points or credits in a first game may not have the same value as 10 virtual points or credits in a second game). For example, the point conversion device may receive, from the gaming console or from a backend device associated with the game, information associated with the virtual economy of the game. The information may indicate a value of a virtual point within the virtual economy of the game. The point conversion device may use such information to determine the user-specific exchange for the game.

As shown by reference number 124, the point conversion device may determine propensity scores associated with the user and other games (e.g., in a similar, or the same, manner as described elsewhere herein). For example, the point conversion device may determine a second propensity score, associated with a second game, based on the user profile. The point conversion device may determine a second exchange rate for converting the program points to virtual points of the second game. The second exchange rate may be different than the first exchange rate (e.g., associated with the game and determined as described above). The second exchange rate may be based on the user profile and/or the second propensity score. The second exchange rate may be specific to the user and the second game (e.g., and may be optimized as described above). In other words, the point conversion device may determine different exchange rates, associated with the user, for converting program points to different virtual points of different games (e.g., based on propensity scores associated with the user and the different games).

In some implementations, the point conversion device may determine different exchange rates, associated with the same virtual points and/or the same game, for different users (e.g., based on the different users being associated with different propensity scores). For example, the point conversion device may obtain a second user profile associated with a second user (e.g., where the user described above is a first user and the user profile described above is a first user profile). The point conversion device may determine a second exchange rate for converting the program points to the virtual points of the game. In some implementations, the second exchange rate is based on the second user profile. In some implementations, the second exchange rate is different than the exchange rate that is determined as described above (e.g., the first user and the second user may be associated with different exchange rates for converting the program points to the same virtual points). In some implementations, the second exchange rate is specific to the second user and the game (e.g., and is optimized for the second user based on the propensity score, as described in more detail above).

As shown in FIG. 1C, and by reference number 126, the point conversion device may cause one or more user-specific exchange rates, associated with the user, to be displayed. For example, the point conversion device may provide a user interface for display (e.g., by a user device or another device associated with the user). The user interface may indicate the user-specific exchange rate and one or more other user-specific exchange rates associated with other gaming applications or other video games. For example, as shown by reference number 128, the user interface may display the one or more user-specific exchange rates associated with the user. For example, the point conversion device may determine a first user-specific exchange rate (e.g., 3.0) for the first virtual point (e.g., “Z Bucks”) associated with the first game (e.g., “Game 1”), a second user-specific exchange rate (e.g., 0.5) for the second virtual point (e.g., “Y Points”) associated with the second game (e.g., “Game 2”), a third user-specific exchange rate (e.g., 1.3) for the third virtual point (e.g., “B credits”) associated with the third game (e.g., “Game 3”), and so on.

As shown in FIG. 1C, the user-specific exchange rates may be different than the base exchange rates (e.g., depicted in FIG. 1A). For example, the user-specific exchange rates may be optimized to incentivize the user to accept an offer to convert program points to virtual points according to the user-specific exchange rates. As a result, by using information provided by the gaming console and/or the user profile, the point conversion device may be enabled to determine an optimized, user-specific, exchange rate associated with a given game and a given virtual point quickly and accurately. For example, the point conversion device may use information, such as memory usage information associated with the gaming console, provided by the gaming console and/or the user profile to improve the determination of the user-specific exchange rates. This conserves computing resources (e.g., processing resources and/or memory resources) that would have otherwise been used by the point conversion device to perform one or more iterations of determining an exchange rate, deploying the exchange rate to be used by users, receiving feedback associated with redemptions and/or conversions performed by users based on the exchange rate, and adjusting the exchange rate based on the feedback, until the optimized exchange rate is determined by the point conversion device.

As shown by reference number 130, the point conversion device may receive a request to exchange program points to virtual points of a given game according to a user-specific exchange rate (e.g., that is displayed via the user interface). For example, the user may interact with the user interface to initiate the exchange of program points to virtual points of a first game according to a first user-specific exchange rate associated with the game. The point conversion device may receive an indication of a quantity of program points to be converted to the virtual points of the first game. The point conversion device may determine, based on the first user-specific exchange rate, a quantity of the virtual points that are to be made available based on completing the exchange. For example, the exchange may convert one or more of the program points to one or more digital assets or virtual points of the first game (e.g., of a first gaming application) according to the first user-specific exchange rate.

As shown by reference number 132, the point conversion device may communicate, with the backend system, to cause the quantity of virtual points to be made available to (e.g., to be added to) an account associated with the first game. In some implementations, the account may be associated with the user. In some implementations, the account may be associated with another user (e.g., a child of the user or a spouse of the user, among other examples). The point conversion device may transmit, to the backend system, identifying information of the account (e.g., an account identifier or a username, among other examples) and an indication of the quantity of virtual points to be added to the account. The backend system may be associated with the first game. The backend system may cause the quantity of virtual points to be made available to the account. As a result, when the user (or another user) logs in to the account via the first game or a gaming platform associated with the first game, the user may be enabled to use the virtual points for in-game purchases associated with the first game. The point conversion device may similarly communicate with other backend systems associated with other games based on receiving an indication of exchanges of program points to virtual points associated with the other games.

As indicated above, FIGS. 1A-1C are provided as an example. Other examples may differ from what is described with regard to FIGS. 1A-1C.

FIG. 2 is a diagram illustrating an example 200 of training and using a machine learning model in connection with optimized exchange rates based on user profiles. The machine learning model training and usage described herein may be performed using a machine learning system. The machine learning system may include or may be included in a computing device, a server, a cloud computing environment, the point conversion device, the gaming console, and/or the backend system, described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the gaming console and/or the point conversion device, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the gaming console and/or the point conversion device. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of “days from game release date” (e.g., a quantity of days from a current date to a release date of the game), a second feature of “game in a category played by user?” (e.g., of whether a category of the game is included in categories of games typically played by the user), a third feature of “game owned by the user?” (e.g., of whether the game is owned by the user), and so on. As shown, for a first observation, the first feature may have a value of “5”, the second feature may have a value of “Yes”, the third feature may have a value of “Yes”, and so on. These features and feature values are provided as examples, and may differ in other examples. For example, the feature set may include one or more of the following features: an amount of time that the user has played the game, a frequency or periodicity associated with the user playing the game, a memory usage, associated with the game, of a gaming console, one or more categories of entity or one or more entities indicated by a transaction history of the user, and/or other information indicated by a user profile of the user (e.g., as described in more detail elsewhere herein).

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is “propensity score”, which has a value of 95 for the first observation.

The feature set and target variable described above are provided as examples, and other examples may differ from what is described above. For example, for a target variable of a user-specific exchange rate, the feature set may include a propensity score associated with the user and/or other information indicated by a user profile of the user (e.g., as described in more detail elsewhere herein.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of “days from game release date”, a second feature of “game in a category played by the user?”, a third feature of “game owned by the user?”, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of “propensity score” for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, that the user is likely to redeem program points for virtual points associated with the game. The first automated action may include, for example, causing a base exchange rate associated with the game to be increased, or transmitting, to a point conversion device, an indication to increase the base exchange rate associated with the game.

As another example, if the machine learning system were to predict a value of 10 for the target variable of “propensity score”, then the machine learning system may provide a second (e.g., different) recommendation (e.g., that the user is not likely to redeem program points for virtual points associated with the game) and/or may perform or cause performance of a second (e.g., different) automated action (e.g., causing a base exchange rate associated with the game to be decreased).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., games with a propensity score, of the user, satisfying a first threshold), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., games with a propensity score, of the user, that does not satisfy the first threshold), then the machine learning system may provide a second (e.g., different) recommendation (e.g., such as the second recommendation described above) and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. For example, the recommendations associated with a likelihood that the user will redeem program points for virtual points associated with the game may include a recommended user-specific exchange rate associated with the user and the game (e.g., that is based on the propensity score).

In this way, the machine learning system may apply a rigorous and automated process to determine optimized exchange rates based on user profiles. The machine learning system enables recognition and/or identification of tens, hundreds, thousands, or millions of features and/or feature values for tens, hundreds, thousands, or millions of observations, thereby increasing accuracy and consistency and reducing delay associated with determining optimized exchange rates based on user profiles relative to requiring computing resources to be allocated for tens, hundreds, or thousands of operators to manually determine optimized exchange rates based on user profiles using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a point conversion device 310, a gaming console 320, a backend device 330, and a network 340. Devices of environment 300 may interconnect via wired connections, wireless connections, or a combination of wired and wireless connections.

The point conversion device 310 includes one or more devices capable of receiving, generating, storing, processing, providing, and/or routing information associated with optimized exchange rates based on user profiles, as described elsewhere herein. The point conversion device 310 may include a communication device and/or a computing device. For example, the point conversion device 310 may include a server, such as an application server, a client server, a web server, a database server, a host server, a proxy server, a virtual server (e.g., executing on computing hardware), or a server in a cloud computing system. In some implementations, the point conversion device 310 includes computing hardware used in a cloud computing environment.

The gaming console 320 includes one or more devices capable of receiving, generating, storing, processing, and/or providing information associated with optimized exchange rates based on user profiles, as described elsewhere herein. The gaming console 320 may include a communication device and/or a computing device. For example, the gaming console 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. In some implementations, the gaming console 320 may be a device capable of executing one or more video game applications or programs. The gaming console 320 may include a home console, a stationary console, a handheld console, and/or a portable console, among other examples.

The backend device 330 includes one or more devices capable of receiving, generating, storing, processing, providing, and/or routing information associated with optimized exchange rates based on user profiles, as described elsewhere herein. The backend device 330 may include a communication device and/or a computing device. For example, the backend device 330 may include a server, such as an application server, a client server, a web server, a database server, a host server, a proxy server, a virtual server (e.g., executing on computing hardware), or a server in a cloud computing system. In some implementations, the backend device 330 includes computing hardware used in a cloud computing environment.

The network 340 includes one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the point conversion device 310, the gaming console 320, and/or the backend device 330. In some implementations, the point conversion device 310, the gaming console 320, and/or the backend device 330 include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

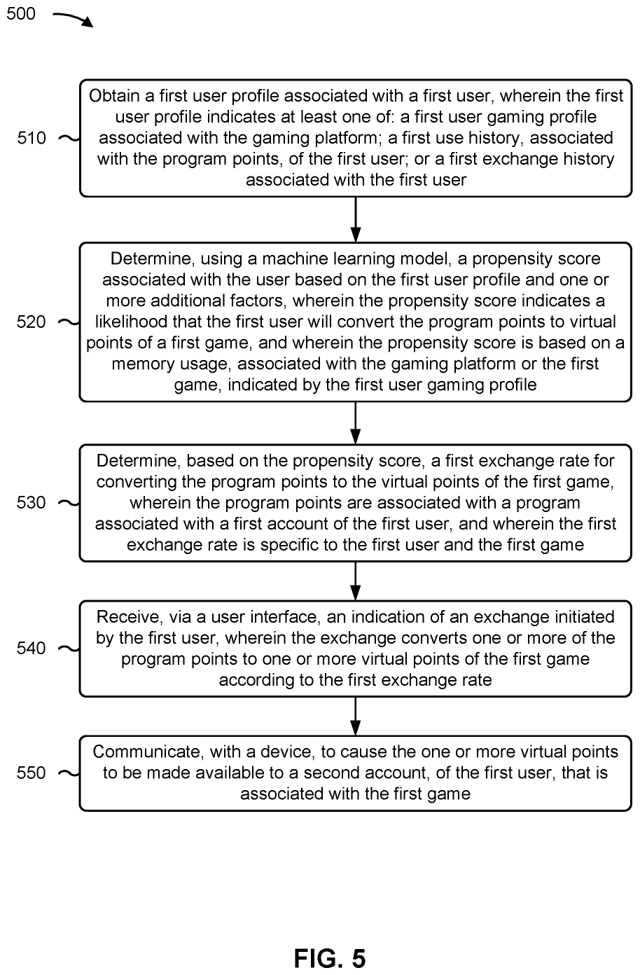

FIG. 5 is a flowchart of an example process 500 associated with optimized exchange rates based on user profiles. In some implementations, one or more process blocks of FIG. 5 may be performed by a point conversion device (e.g., the point conversion device 310). In some implementations, one or more process blocks of FIG. 5 may be performed by another device or a group of devices separate from or including the point conversion device, such as the gaming console 320 and/or the backend device 330, among other examples. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include obtaining a first user profile associated with a first user (block 510). In some implementations, the first user profile indicates at least one of: a first user gaming profile associated with the gaming platform; a first use history, associated with the program points, of the first user; or a first exchange history associated with the first user. As further shown in FIG. 5, process 500 may include determining, using a machine learning model, a propensity score associated with the user based on the first user profile (block 520). In some implementations, the propensity score indicates a likelihood that the first user will convert the program points to virtual points of a first game. In some implementations, the propensity score is based on a memory usage, associated with the gaming platform or the first game, indicated by the first user gaming profile. As further shown in FIG. 5, process 500 may include determining, based on the propensity score, a first exchange rate for converting the program points to the virtual points of the first game (block 530). In some implementations, the program points are associated with a program associated with a first account of the first user. In some implementations, the first exchange rate is specific to the first user and the first game. As further shown in FIG. 5, process 500 may include receiving, via a user interface, an indication of an exchange initiated by the first user (block 540). In some implementations, the exchange converts one or more of the program points to one or more virtual points of the first game according to the first exchange rate. As further shown in FIG. 5, process 500 may include communicating, with a device, to cause the one or more virtual points to be made available to a second account that is associated with the first game (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and 2.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for a user-specific exchange rate based on user profiles for converting program points to virtual points of a gaming platform, the system comprising:
one or more memories; and
one or more processors, coupled to the one or more memories, configured to:
obtain a first user profile associated with a first user, wherein the first user profile indicates a first user gaming profile associated with the gaming platform, and at least one of: a first use history, associated with the program points, of the first user, or a first exchange history associated with the first user, the first user gaming profile indicating a memory usage associated with the first game;
determine, using a machine learning model, a propensity score associated with the first user based on the first user profile, wherein the propensity score indicates a likelihood that the first user will convert the program points to virtual points of a first game, and wherein the machine learning model is trained using a feature set that includes the memory usage;
determine, based on the propensity score, a first exchange rate for converting the program points to the virtual points of the first game, wherein the program points are associated with a program associated with a first account of the first user, and wherein the first exchange rate is specific to the first user and the first game;
receive, via a user interface, an indication of an exchange initiated by the first user, wherein the exchange converts one or more of the program points to one or more virtual points of the first game according to the first exchange rate; and
communicate, with a device, to cause the one or more virtual points to be made available to a second account that is associated with the first game.

2. The system of claim 1, wherein the one or more processors, to determine the first exchange rate, are configured to:
determine a highest exchange rate, from the program points to the virtual points, for the first user that is likely to incentivize the first user to exchange the program points for the virtual points based on the propensity score.

3. The system of claim 1, wherein the one or more processors are further configured to:
determine a second exchange rate for converting the program points to virtual points of a second game associated with the gaming platform, wherein the second exchange rate is different than the first exchange rate, wherein the second exchange rate is based on the first user profile, and wherein the second exchange rate is specific to the first user and the second game.

4. The system of claim 1, wherein the one or more processors are further configured to:
obtain a second user profile associated with a second user; and
determine a second exchange rate for converting the program points to the virtual points of the first game associated with the gaming platform, wherein the second exchange rate is based on the second user profile, and wherein the second exchange rate is specific to the second user and the first game.

5. The system of claim 1, wherein the first exchange rate is further based on at least one of:
a first release date of the first game,
a second release date of a feature or content associated with the first game,
an acquisition date of the first game by the first user, or
an acceptance rate of exchanges according to other exchange rates associated with the first game and associated with other users.

6. The system of claim 1, wherein the program points are earned via one or more transactions with one or more entities, and wherein the virtual points are associated with acquiring in-game digital assets.

7. The system of claim 1, wherein the first user gaming profile further indicates at least one of:
one or more categories of games associated with the first user,
a gaming experience level associated with the first user, or
an indication of an amount of time that the first user has been active on the gaming platform or the first game.

8. A method for determining an exchange rate for converting program points to digital assets of a gaming platform, comprising:
obtaining, by a device, a first user profile associated with a first user, the first user profile indicating a memory usage associated with a first gaming application;
determining, by the device and using a machine learning model trained using a feature set that includes the memory usage, a first exchange rate for converting the program points to one or more digital assets of the first gaming application associated with the gaming platform, wherein the program points are associated with a program associated with a first account of the first user, and wherein the first exchange rate is specific to the first user and the first gaming application;
receiving, by the device and via a user interface associated with the first account, an indication of an exchange initiated by the first user, wherein the exchange converts one or more of the program points to the one or more digital assets of the first gaming application according to the first exchange rate; and
communicating, by the device with a server device, to cause the one or more digital assets to be made available to a second account that is associated with the first gaming application.

9. The method of claim 8, wherein determining the first exchange rate comprises:
determining an optimized exchange rate, from the program points to the one or more digital assets, for the first user based on the first user profile, wherein the optimized exchange rate is optimized to conserve the program points and cause the first user to accept an offer to convert the program points to the one or more digital assets.

10. The method of claim 8, further comprising:
determining a second exchange rate for converting the program points to the one or more digital assets of a second gaming application associated with the gaming platform, wherein the second exchange rate is different than the first exchange rate, wherein the second exchange rate is based on the first user profile, and wherein the second exchange rate is specific to the first user and the second gaming application.

11. The method of claim 8, further comprising:
obtaining a second user profile associated with a second user; and
determining a second exchange rate for converting the program points to the one or more digital assets of the first gaming application associated with the gaming platform, wherein the second exchange rate is based on the second user profile, and wherein the second exchange rate is specific to the second user and the first gaming application.

12. The method of claim 8, wherein the first exchange rate is based on one or more factors, and wherein the one or more factors include at least one of:
a first release date of the first gaming application,
a second release date of a feature or content associated with the first gaming application,
an acquisition date of the first gaming application by the first user, or
an acceptance rate of exchanges according to other exchange rates associated with the first gaming application and other users.

13. The method of claim 8, wherein the first user profile indicates a user gaming profile associated with the first user, wherein the user gaming profile indicates a likelihood that the first user will play the first gaming application, and wherein the first exchange rate is based on the user gaming profile.

14. The method of claim 8, wherein the first user profile indicates a transaction history associated with the first user, wherein the transaction history indicates a likelihood that the first user has purchased the first gaming application, and wherein the first exchange rate is based on the transaction history.

15. The method of claim 8, further comprising:
providing the user interface for display, wherein the user interface indicates the first exchange rate and one or more other exchange rates associated with other gaming applications.

16. The method of claim 8, wherein determining the first exchange rate comprises:
determining the first exchange rate using the machine learning model, wherein parameters indicated by the first user profile and one or more additional factors are provided as inputs to the machine learning model.

17. A non-transitory computer-readable medium storing a set of instructions, the set of instructions comprising:
one or more instructions that, when executed by one or more processors of a device, cause the device to:
obtain a first user profile associated with a first user, the first user profile indicating a memory usage associated with a first game;
determine, using a machine learning model trained using a feature set that includes the memory usage, a first exchange rate for converting program points to virtual points of the first game, wherein the program points are associated with a program associated with a first account of the first user, and wherein the first exchange rate is specific to the first user and the first game;
provide an indication of the first exchange rate for display via a user interface associated with the first account;
receive, via the user interface, an indication of an exchange initiated by the first user, wherein the exchange converts one or more of the program points to one or more virtual points of the first game according to the first exchange rate; and
communicate, with another device, to cause the one or more virtual points to be made available to a second account, of the first user, that is associated with the first game.

18. The non-transitory computer-readable medium of claim 17, wherein the one or more instructions further cause the device to:
determine a second exchange rate for converting the program points to virtual points of a second game, wherein the second exchange rate is different than the first exchange rate, wherein the second exchange rate is based on the first user profile, and wherein the second exchange rate is specific to the first user and the second game.

19. The non-transitory computer-readable medium of claim 17, wherein the one or more instructions further cause the device to:
obtain a second user profile associated with a second user; and
determine a second exchange rate for converting the program points to the virtual points of the first game, wherein the second exchange rate is based on the second user profile and one or more additional factors, and wherein the second exchange rate is specific to the second user and the first game.

20. The non-transitory computer-readable medium of claim 17, wherein the first exchange rate is based on at least one of:
a user gaming profile associated with the first user, wherein the first user profile indicates the user gaming profile, and wherein the user gaming profile indicates a first likelihood that the first user will play the first game; or
a transaction history associated with the first user, wherein the transaction history indicates a second likelihood that the first user has purchased the first game.
